(19) United States
(12) Patent Application Publication
(10) Pub. No.: US 2022/0369663 A1
(43) Pub. Date: Nov. 24, 2022

(54) METHODS FOR USING TEMPEH/TEMPE IN FOOD PRODUCTS

(71) Applicants: Angeline Leong, Singapore (SG); Andrew Goh Beng Kiat, Singapore (SG)

(72) Inventors: Angeline Leong, Singapore (SG); Andrew Goh Beng Kiat, Singapore (SG)

(21) Appl. No.: 17/745,959

(22) Filed: May 17, 2022

Related U.S. Application Data
(60) Provisional application No. 63/190,389, filed on May 19, 2021.

(51) Int. Cl. A23J 3/16; A23L 5/10

(52) U.S. Cl. CPC A23J 3/16; A23L 5/11

(57) ABSTRACT

A method to create a tempeh food product and a novel tempeh food product are described herein. The tempeh food product is natural, wholesome, plant-based, non-GMO, gluten-free, cholesterol-free, low in sodium, unpasteurized, low in saturated fat, and vegan. In examples, the tempeh food product is a tempeh bak kwa, a soy tempeh minced product, or a soy tempeh chip, among others not explicitly listed herein.

### CROSS-REFERENCE TO RELATED APPLICATIONS SECTION

This application is a U.S. Non-Provisional Patent Application that claims priority to U.S. Provisional Patent Application Ser. No. 63/190,389 filed on May 19, 2021, the entire contents of which are hereby incorporated by reference in their entirety.

### FIELD OF THE EMBODIMENTS

The field of the invention and its embodiments relate to a new tempeh product that is natural, wholesome, plant-based, non-GMO, gluten-free, unpasteurized, cholesterol-free, low in sodium, low in saturated fat, and vegan. Moreover, the field of the invention and its embodiments relate to a novel production method to create the new tempeh product.

### BACKGROUND OF THE EMBODIMENTS

Tempeh is a traditional fermented food created from soybeans that has been eaten for 500 years in Indonesia. Most tempeh in Indonesia is wrapped and sold in banana leaves. Tempeh has a cake-like appearance, in which each soybean is embedded in white hyphae. Though similar to natto, tempeh does not have the strong smell and stickiness that natto has, and tempeh retains its cake-like shape even when sliced. Thus, tempeh may be used in various ways as a cooking material.

Tempeh is typically prepared through fermentation with Rhizopus oligosporous, which exhibits fermenting ability not only in soybeans, but also in other foods. Therefore, foods prepared by the fermentation of beans, grains, and nuts with Rhizopus oligosporous have been known. However, what is needed is a new tempeh product that is natural, wholesome, plant-based, non-GMO, gluten-free, unpasteurized, cholesterol-free, low in sodium, low in saturated fat, and vegan. Moreover, what is needed a novel production method to create the new tempeh product.

### Examples of Related Art Include:

KR19900008211B1 describes a process for making tempeh by the fermentation of fungi and yeast. The process comprises: peeling soybeans, soaking the soybeans in an acid solution at room temperature for 24 hours, sterilizing the soybeans at 90-100° C. hot water for 30-60 minutes, drying the soybeans, cooling the soybeans, inoculating 2-3 wt. % of a Rhizopus oligosporus culture broth and 1-5 wt. % of one or more of yeast culture broth into the soybeans, and incubating the soybeans at 25-37° C. for 20-36 hours.

U.S. Pat. No. 3,681,085A describes a method to produce an edible food product. The method comprises: preparing a fermentable admixture comprising tempeh and sterilized fatty meat pieces, fish pieces, or fish meal acidified to a pH in the range 4-6, fermenting the resulting admixture at a temperature in the range 85-115° F. for 5-40 hours at a relative humidity greater than about 50%, and sterilizing the resulting fermented admixture. The sterilized fermented admixture contains 20-90% by weight tempeh.

U.S. Pat. No. 3,762,933A describes tempeh and components thereof, such as an oil for tempeh and an extract of tempeh, which are useful as stabilizers for food compositions, particularly edible fats and oils.

JP3223001U describes a high quality tempeh production machine.

CN109497496A describes creation of tempeh condiments. Fermented fresh tempeh is beaten and colloid-milled to produce thick tempeh paste. Soy sauce is added for extraction. Then, filtration is carried out to produce the tempeh soy source. Oyster water may be replaced with the tempeh paste to produce tempeh oyster sauce. Further, tempeh jam is produced by adding auxiliary materials, such as a fruit, sugar, and citric acid.

JP6435865B2 describes a method for producing a tempeh fermentation product, where the filamentous fungi is a Rhizopus microsporus var. chinensis 3005 strain.

CN107410504A describes creation of a tempeh milk powder. Soybeans are fermented with Rhizopus oryzae to prepare the tempeh. The tempeh is added to milk and soybean milk so as to produce novel healthy beverages (foods) having higher nutritional value than milk and soybean milk.

CN104719780A describes a food material mixed with Rhizopus oligosporus. The food material comprises the following components in parts by weight: 80 to 99.999 parts of food materials, 0.001 to 20 parts of Rhizopus oligosporus, and 0 to 150 parts of water.

AU2013263855B2 and AU2014100641A4 describe an isolated Rhizopus oligosporus strain which is suited for the production of fermented food products, such as tempeh.

TW201343172A describes a fungus identified as Rhizopus oligosporus, which is used in the production of active elements to decrease the blood pressure.

CN102907626A describes a method to make dehydrated tempeh. The method includes: immersing soybeans in water, peeling and smashing the soybeans, and placing the smashed soybeans into a high-pressure cooker. Next, the method includes: sterilizing the soybeans for 20 minutes at a temperature of 121° C., mixing rice meal and corn flour (which respectively account for 1 percent of dry weight of soybeans), uniformly stirring and cooling the mixture to 35° C., inserting Rhizopus oligosporus seed (which accounts for 4 percent of the dry weight of soybeans), and uniformly stirring the mixture. The method then includes: fermenting the mixture for 20-22 hours at a temperature of 30-32° C. and a relative humidity of 80-85 percent, thereby breeding a white biscuit block grown with white mycelium, namely tempeh. Next, the method includes: cutting the tempeh into square blocks with 2-3 centimeters and drying the tempeh, thus obtaining a tempeh finished product.

CN101878793A describes a method to create a tempeh nutrition bread comprising: 46-50% of wheat flour, 10-15% of tempeh powder, 6-8% of white granulated sugar, 3 to 5% of cream, 1-1.5% of dry yeast, 0.5-2% of salt and 26-28% of water in percentage by weight.

WO2009097653A1 describes an isolated Rhizopus oligosporus strain that is suited for the production of fermented food products, such as tempeh.

JP2009171901A describes a method for producing tempeh-containing cheese. The method includes: mixing tempeh paste obtained by adding water to tempeh-fungi fermented soybean as soybean fermented food; and forcibly beating the mixture with non-aging/salt-free semihard cheese raw material to make the cheese.

JP2007175024A describes a method for producing a tempeh-like fermented food using Rhizopus filamentous fungus. The method includes: soaking soybeans, sprouted soybeans, peanut, rice, brown rice, sprouted brown rice, bean curd lees, corn, wheat, barley and/or adlay; heating the product; sterilizing the product; inoculating the sterilized fermented raw material with Rhizopus filamentous fungus (such as Rhizopus oligosporus or Rhizopus oryzae) and Lactococcus bacillus (such as Lactococcus lactis or Lactococcus raffinolactis); and fermenting the product.

US20070082088A1 describes a novel fermented food obtainable by fermenting sprouted brown rice, or sprouted brown rice and soybeans, with a Rhizopus mold.

JP06319456A describes a method for producing baked confectioneries using fermented soybeans or tempe.

Some similar methods and products exist in the art. However, their means of operation are substantially different from the present disclosure, as the other inventions fail to solve all the problems taught by the present disclosure.

### SUMMARY OF THE EMBODIMENTS

The present invention and its embodiments relate to a new tempeh product that is natural, wholesome, plant-based, non-GMO, gluten-free, unpasteurized, cholesterol-free, low in sodium, low in saturated fat, and vegan. Moreover, the present invention and its embodiments relate to a novel production method to create the new tempeh product.

A first embodiment of the present invention describes a method to create a tempeh food product. The method includes numerous process steps, such as: soaking soybeans in a dye for a first time period, cooking the soybeans with a component (e.g., a powder) for a second time period, fermenting the soybeans for a third time period to form a tempeh, slicing the tempeh, cooling the tempeh to reduce a moisture content on a surface of the tempeh, deep frying the tempeh in an oil for a fourth time period, dipping the tempeh into a first sauce, cooking the tempeh in a combi oven at a first temperature for a fifth time period, dipping the tempeh into a second sauce, cooking the tempeh in the combi oven at a second temperature for a sixth time period, and grilling the tempeh. A tempeh bak kwa is created by this method.

A second embodiment of the present invention describes a minced food product that includes soy tempeh, an isolate, and an oil (e.g., sunflower oil or coconut oil).

A third embodiment of the present invention describes a chip food product comprising a soy tempeh and a flour (e.g., potato starch four). A moisture level of the chip food product is in a range between approximately 50% and approximately 70%.

In general, the present invention succeeds in conferring the following benefits and objectives.

It is an object of the present invention to provide a novel tempeh product that is natural, wholesome, plant-based, non-GMO, gluten-free, unpasteurized, cholesterol-free, low in sodium, low in saturated fat, and vegan.

It is an object of the present invention to provide a novel production method to create the new tempeh product.

It is an object of the present invention to provide a novel production method to create the new tempeh product, where the production method uses customized equipment that includes a customized temperature controlled incubator room.

### BRIEF DESCRIPTION OF THE DRAWINGS

FIG. 1 depicts a block diagram of a method to create a tempeh bak kwa, according to at least some embodiments described herein.

FIG. 2 depicts an image of a soy tempeh as a base ingredient with 2% soy isolate, according to at least some embodiments described herein.

FIG. 3 depicts an image of a soy tempeh as a base ingredient with 10% soy isolate, according to at least some embodiments described herein.

FIG. 4 depicts an image of a 20% soy tempeh solids and 80% soy tempeh isolate mixture, according to at least some embodiments described herein.

FIG. 5 depicts an image of a sample of a soy minced product, according to at least some embodiments described herein.

FIG. 6 depicts an image of a soy tempeh minced product for use in the food services market that includes about 2% of soy isolate, according to at least some embodiments described herein.

FIG. 7 depicts an image of a soy tempeh minced product for use in the food services market that includes about 10% of soy isolate, according to at least some embodiments described herein.

FIG. 8 depicts an image of a soy tempeh minced product for use in the food services market that includes a mixture of about 20% soy tempeh solids and about 80% tempeh isolate, according to at least some embodiments described herein.

FIG. 9 depicts an image of a sample soy minced product, according to at least some embodiments described herein.

FIG. 10 depicts an image of Low Density Polyethylene (LDPE) tubing used to make a soybean tempeh chip product, according to at least some embodiments described herein.

FIG. 11 depicts an image of a solid state fermentation, according to at least some embodiments described herein.

FIG. 12 depicts an image of soybean tempeh chip product, according to at least some embodiments described herein.

FIG. 13 depicts another image of soybean tempeh chip product, according to at least some embodiments described herein.

FIG. 14 depicts a further image of soybean tempeh chip product post deep-frying, according to at least some embodiments described herein.

FIG. 15 depicts an image of a dry substrate product with a food coloring soaked in a water mixture, according to at least some embodiments described herein.

FIG. 16 depicts an image of a boiled soybean product, according to at least some embodiments described herein.

FIG. 17 depicts an image of a solid red brick-like product resulting from solid state fermentation of a bakkwa/jerky tempeh product, according to at least some embodiments described herein.

FIG. 18 depicts an image of a vacuum sealed bakkwa/jerky tempeh product with a sauce/marinade, according to at least some embodiments described herein.

FIG. 19 depicts an image of a baked bakkwa/jerky tempeh product, according to at least some embodiments described herein.

FIG. 20 depicts an image of a final bakkwa/jerky tempeh product, according to at least some embodiments described herein.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

### Tempeh

Tempeh or tempe is a fermented soybean preparation that has been an important food product for centuries in the Far East. More specifically, tempeh is a white mold-covered cake resulting from the fermentation by Rhizopus oligosporous fungus upon its substrate, which can be legumes, grains, or seeds. More specifically, Rhizopus oligosporous is a fungus of the family Mucoraceae and is a widely used starter culture for the production of tempeh at home and industrially. As the mold grows, it produces fluffy, white mycelia, binding the beans together to create an edible “cake” of partly catabolized soybeans. Rhizopus oligosporous is the preferred starter culture for tempeh production since: (1) it grows effectively in warm temperatures (e.g., between 30-40° C. or 85-105° F.), (2) it exhibits strong lipolytic and proteolytic activity, creating desirable properties in the tempeh, and (3) it produces metabolites that allows it to inhibit and thus outcompete other molds and gram-positive bacteria.

Tempeh is an important food product, in that it contains proteins, carbohydrates, fats, vitamins, and other nutrients. Compared with unfermented soybeans, the riboflavin content is significantly higher in tempeh. Tempeh also has antihypertensive, antidiabetic, antioxidative and antitumor peptides. See, Badrut Tamam, et al., “Proteomic study of bioactive peptides from tempe,” Journal of Bioscience and Bioengineering, 2019, Vol. 128, Issue 2, Pages 241-248, the entire contents of which are hereby incorporated by reference in their entirety.

Tempeh is generally prepared by soaking whole soybeans in water and dehulling the beans. The dehulled soybeans are then boiled to soften the soybeans and the cooked soybeans are then spread out in thin layers (e.g., 1-2 inches deep) and permitted to air dry. The soybeans are typically then inoculated with molded soybean materials or tempeh from a previous tempeh fermentation and the inoculated soybeans are permitted to ferment until the soybeans are substantially completely molded. The resulting soybean product is known as tempeh. Other unique techniques for the production of tempeh are known, such as those described in U.S. Pat. Nos. 3,228,773 and 3,243,301, the entire contents of which are hereby incorporated by reference in their entirety.

Though similar, tempeh differs from tofu, in that tempeh is made from whole soybeans and tofu is made from the coagulation of soybean milk and a binding agent. Also, tempeh includes dietary fiber that is not present in tofu. Tempeh is also less processed then tofu. Further, tempeh is fermented and tofu is not. The fermentation process not only deactivates the anti-nutrients in soybeans that cause gas as indigestion, but also adds B complex vitamins. Thus, tempeh is more readily digestible and nutritious as compared to tofu. Further, tempeh is a better meat substitute in most dishes as compared to tofu, since tempeh has a firmer, more chewy, “meatier” texture. Additionally, the fermentation and enzymatic breakdown of proteins in tempeh contributes greater umami, or savory, compounds that are not found in tofu.

Various tempeh food products are described by the present invention, such as tempeh bak kwa, a soy tempeh minced product, and a soy tempeh chip. These tempeh food products are natural, wholesome, plant-based, non-GMO, gluten-free, unpasteurized, cholesterol-free, low in sodium, low in saturated fat, and vegan. Though the food products described herein utilize soybeans, it should be appreciated that in other examples of the present invention, other materials may be used, such as: chickpeas, buckwheat, quinoa, and/or black beans, among others not explicitly listed herein.

### Example 1—Tempeh Bak Kwa

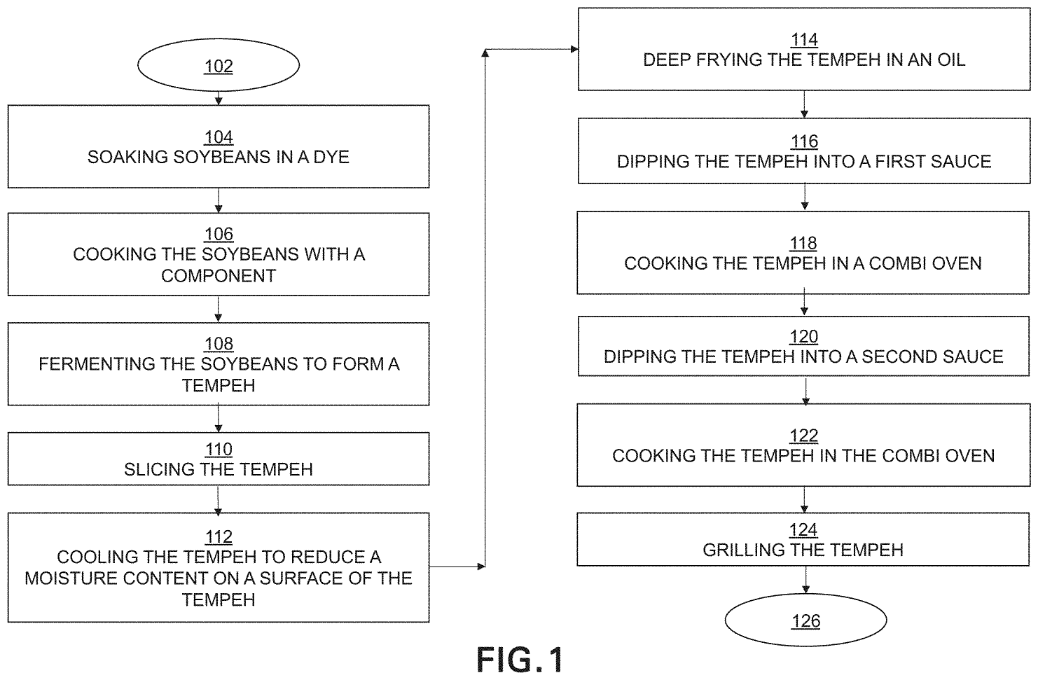

A block diagram of a method to create a tempeh food product is depicted in FIG. 1. The tempeh formed from the method of FIG. 1 is a tempeh bak kwa, which is a salty-sweet, dried meat product similar to jerky.

The method of FIG. 1 begins at a process step 102. A process step 104 follows the process step 102 and includes soaking soybeans in a dye for a first time period. In some examples, customized equipment may be used for the process step 104. In examples, an amount of the soybeans is present in a range between approximately 1 kg-30 kg. Moreover, in some examples, the dye is approximately 15 g-50 g of a red dye.

As described in the process step 104, food coloring may be added without affecting the tempeh solid state fermentation. In some examples, between approximately 0.1% and 0.9% of a powder-type food coloring may be added. In other examples, between approximately 0.1% and 0.9% of a liquid-type food coloring may be added. Addition of the powder-type food coloring is preferred over the liquid-type food coloring.

A process step 106 follows the process step 104 and includes cooking the soybeans with a component for a second time period. In some examples, the component comprises a powder, such as a Wu Xiang powder, or a five spice powder. However, it should be appreciated that the component is not limited to such.

In some examples, a drying technique may be used prior to a process step 108. In one example, the drying technique may include a traditional drying technique where the soybeans are dried under the Sun for hours prior to the fermentation of the process step 108. In other examples, the drying technique may include use of an industrial fan with a mixer machine to dry the soybeans prior to fermentation.

The process step 108 follows the process step 106 and includes fermenting the soybeans for a third time period to form a tempeh. In some examples, the soybeans may be fermented inside of a sealed container or a bag. After the first day, the container or bag is flipped to ensure even fermentation for the tempeh. Approximately 1 kg-5 kg of cooked soybeans may be present in each container or bag.

A process step 110 follows the process step 108 and includes slicing the tempeh. In some examples, the tempeh is sliced into squares. In some examples, each slice of the tempeh is approximately 2 mm-10 mm thick.

A process step 112 follows the process step 110 and includes cooling the tempeh (without the container or the bag) to reduce a moisture content on a surface of the tempeh. Such reduction in moisture content makes it easier to handle the tempeh and also prevents the tempeh from sticking together when slicing.

A process step 114 follows the process step 112 and includes deep frying the tempeh in an oil for a fourth time period. In this process step, the oil is heated to a temperature between approximately 160° C.-180° C.

A process step 116 follows the process step 114 and includes dipping the tempeh into a first sauce. In some examples, the first sauce is a honey sweet sauce. A process step 118 follows the process step 1156 and includes cooking the tempeh in a combi oven at a first temperature for a fifth time period. The oven may be set between approximately 150° C.-200° C.

A process step 120 follows the process step 118 and includes dipping the tempeh into a second sauce. In examples, the second sauce comprises a maltose sweet sauce. A process step 122 follows the process step 120 and includes cooking the tempeh in the combi oven at a second temperature of approximately 120° C.-160° C. for a sixth time period.

A process step 124 follows the process step 122 and includes grilling the tempeh until a charred flavor is achieved. It should be appreciated that in other examples, the tempeh may be used as a base for other food products. A process step 126 follows the process step 124 and concludes the method of FIG. 1.

In some examples, one or more herbs and/or spices may be added to the tempeh during the method of FIG. 1 to enhance flavors of the end product without affecting the solid state fermentation, such as a five spice powder, Italian herbs, an onion powder, a salt, and/or a pepper powder, as shown in Table 1 below.

TABLE 1

| Soy Tempeh | 0.5% | 1% | 2% |
|---|---|---|---|
| 5 Spice powder | Successful | Successful | Successful |
| Italian herbs | Successful | Successful | Successful |
| Onion powder | Successful | N/A | N/A |
| Salt | Successful | N/A | N/A |
| Pepper powder | Successful | Successful | Successful |

Thus, as shown by Table 1, the five spice powder, the Italian herbs, or the pepper powder may be added to 0.5% soy tempeh, 1% soy tempeh, or 2% soy tempeh, while maintaining solid state fermentation. The onion powder or the salt may be added to 0.5% soy tempeh while maintaining solid state fermentation. It should be appreciated that these examples are provided for illustrative purposes only and other herbs and/or spices may be used.

### Example 2—Soy Tempeh Minced Product

In another implementation, a soy tempeh minced product may be created. The soy tempeh minced product may be used to replace mincemeat inside of dumplings, buns, and/or wantons, among other food products. In the examples described herein, the soy tempeh may have approximately 20% sunflower oil and approximately 5% coconut oil added.

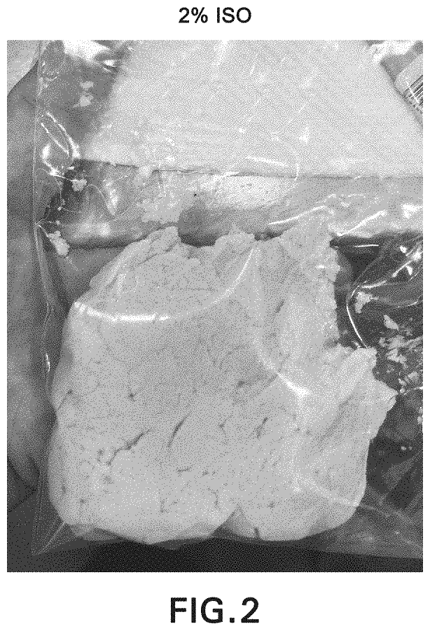

FIG. 2 depicts use of a soy tempeh as a base ingredient with 2% soy isolate, resulting in an oily texture and a very soft feel. The texture associated with this tempeh was similar to a paste.

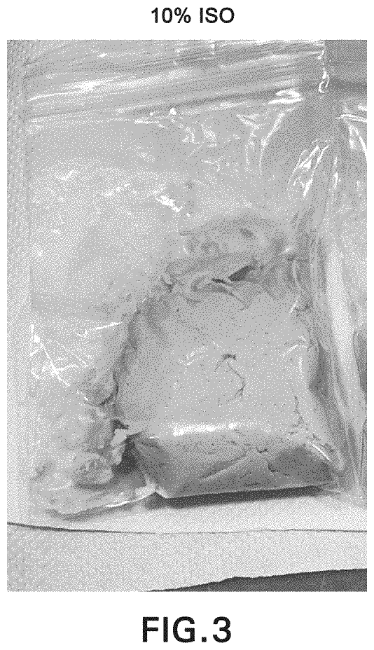

FIG. 3 depicts use of a soy tempeh as a base ingredient with 10% soy isolate, resulting in a thick and more solid texture. The overall texture of the soy tempeh of FIG. 3 was more akin to meat as compared to the soy tempeh of FIG. 2. The emulsion of FIG. 3 was quicker as compared to the emulsion of FIG. 2.

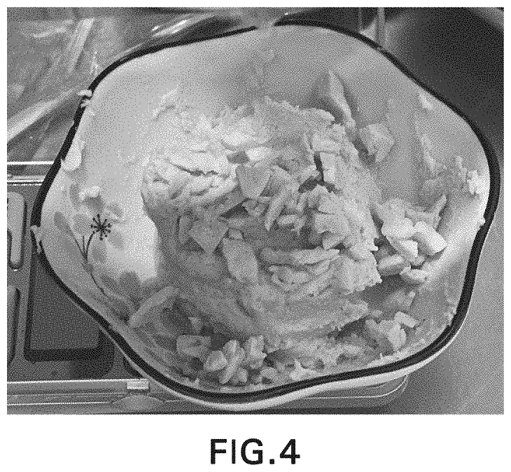

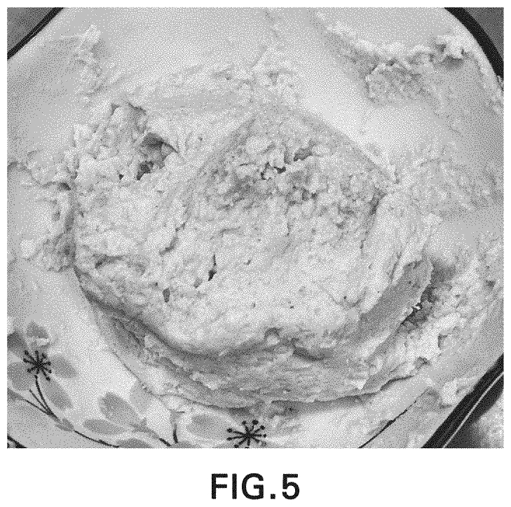

FIG. 4 depicts a 20% soy tempeh solids and 80% soy tempeh isolate mixture and FIG. 5 depicts a sample of the soy minced product.

### Example 3—Soy Tempeh Minced Product for Food Services Market

In another implementation, a soy tempeh minced product may be created for the food services market. This minced product may be used to replace minced meat inside of dumplings, buns, and wontons. In preferred examples, about 20% sunflower oil and about 5% coconut oil may be added to the soy tempeh minced product for the food services market.

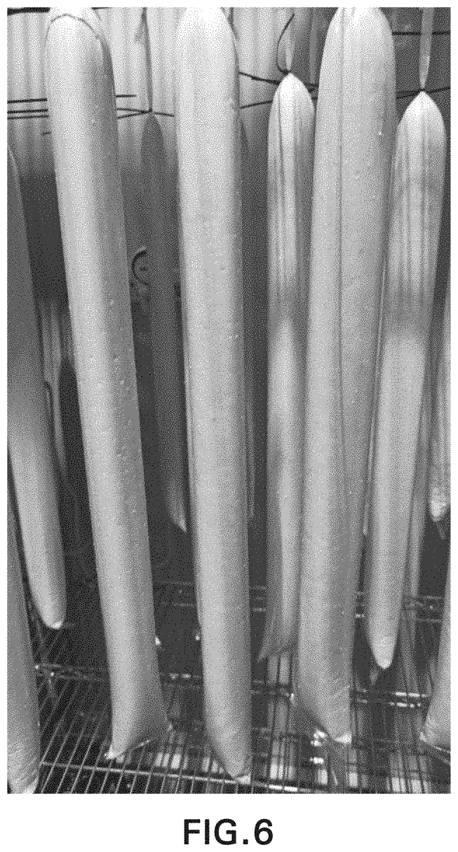

FIG. 6 depicts an image of a soy tempeh minced product for use in the food services market that includes about 2% of soy isolate. This soy tempeh minced product had an oily texture and was very soft to the feel. The texture of this soy tempeh minced product was more similar to paste than to minced meat.

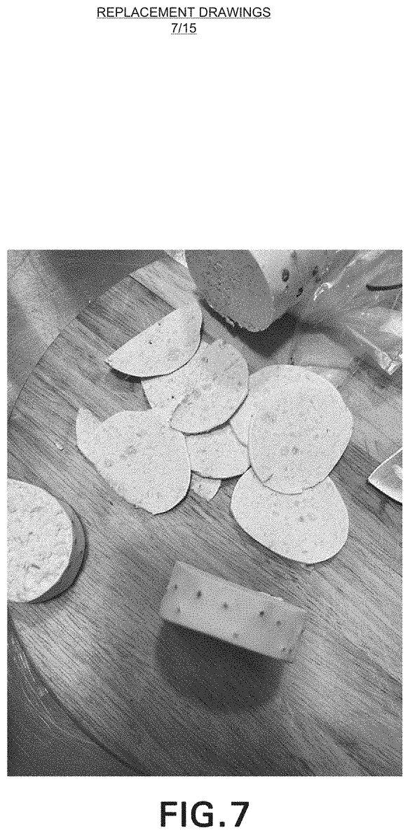

FIG. 7 depicts an image of a soy tempeh minced product for use in the food services market that includes about 10% of soy isolate. This soy tempeh minced product had a thicker and more solid texture as compared to the example of FIG. 6. Overall, the texture of this product was more like meat as compared to the texture of the example in FIG. 6. Further, the time period to create the emulsion was quicker (e.g., about 20 seconds) as compared to the time period to create the emulsion in FIG. 6 (e.g., about 25 seconds).

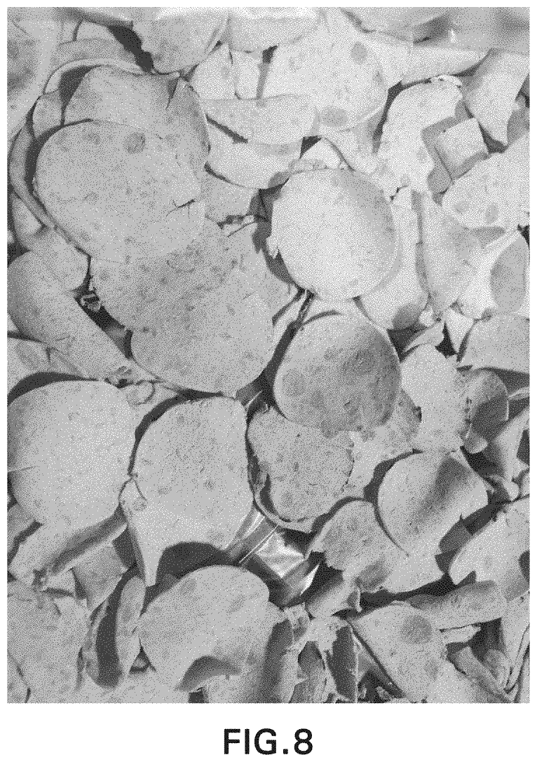

FIG. 8 depicts an image of a soy tempeh minced product for use in the food services market that includes a mixture of about 20% soy tempeh solids and about 80% tempeh isolate.

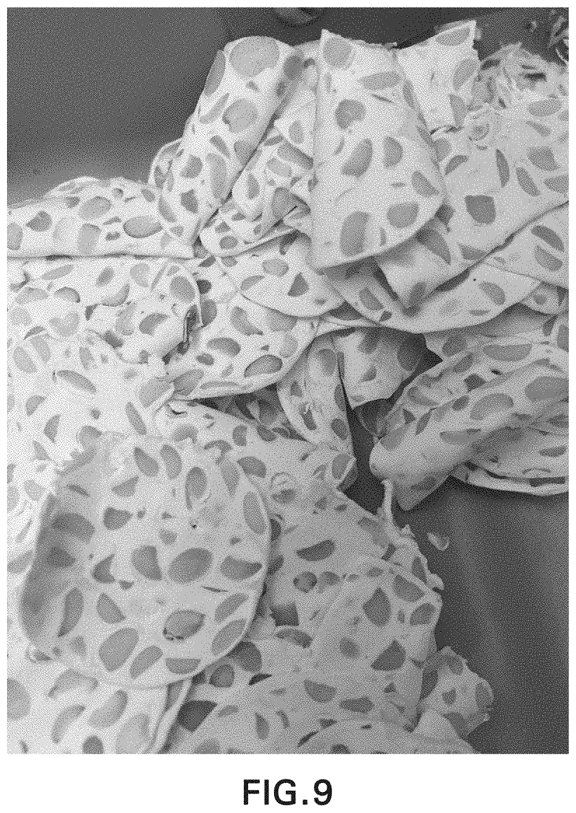

FIG. 9 depicts an image of a sample soy minced product contemplated by Applicant.

### Example 4—Soy Tempeh Chip

The present invention also describes soy tempeh chips. Tempeh chips may be created at varying moisture levels between approximately 50%-70%. In preferred examples, the tempeh chips have a moisture level of approximately 60%/o. Table 2 provides various amounts of a moisture content, a potato starch flour, and a starter amount in examples.

TABLE 2

| | | Potato | Starter |
|---|---|---|---|
| Example | Moisture | starch flour | Amount |
| Number | (%) | (%) | (%) |
| 1 | 57 | 80 | 0.3 |
| 2 | 57 | 80 | 0.4 |
| 3 | 57 | 85 | 0.3 |
| 4 | 57 | 85 | 0.4 |
| 5 | 57 | 85 | 0.5 |
| 6 | 57 | 90 | 0.3 |
| 7 | 57 | 90 | 0.4 |

Examples 1 and 2 were crumbly and unable to hold a shape upon slicing. Out of Examples 3, 4, and 5, Example 4 is preferred as having a lower amount of starter to prolong the lifespan of the product. Examples 6 and 7 both formed a finer exterior, but had too much flour that affected the taste of the final product and were too firm upon compressing.

### Example 5—Soybean Tempeh Chip Product

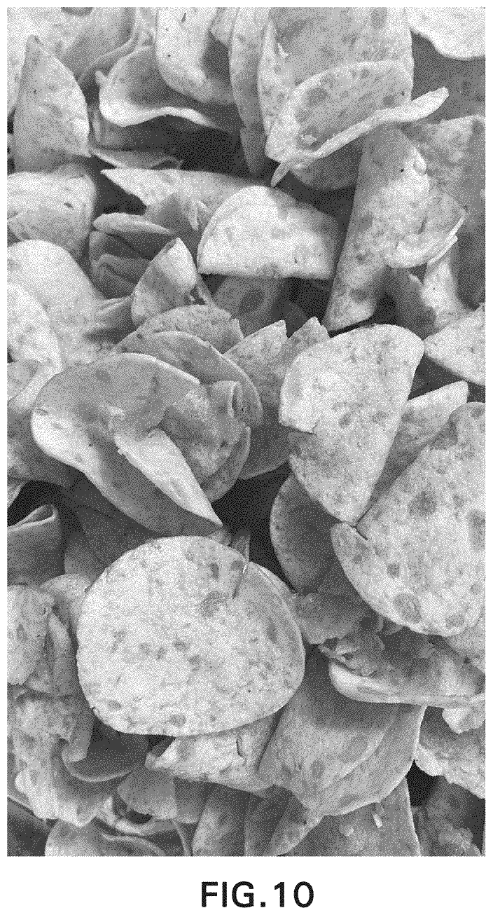

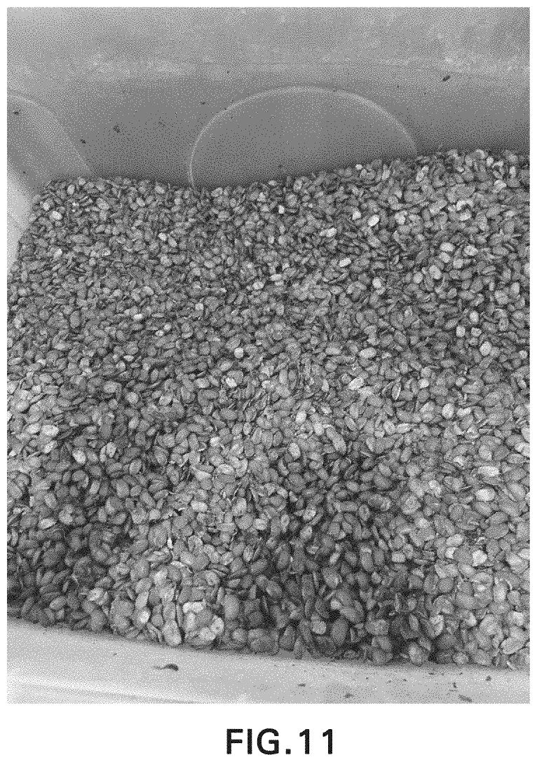

Okara, soy pulp, or tofu dregs is a pulp consisting of insoluble parts of the soybean that remain after pureed soybeans are filtered in the production of soy milk and tofu. It is generally white or yellowish in color. A method is described herein that accepts both pre-heated or ray soybean by-product (e.g., okara). The method includes numerous process steps, such as: dehydrating the soybean by-product (e.g., the okara) at a temperature in a range of about 100° C. to about 120° C. for a time period between about 30 minutes to about 50 minutes. This process step achieves a moisture content of about 60% for the okara. Next, the method includes setting aside the okara to cool to a temperature below about 31° C. Then, the method includes adding starch to the okara in an amount of about 40% to about 100% of the weight of the okara. The starch may include tapioca, potato, corn, wheat, and/or rice starch. Next, the method includes adding the tempeh starter at about 0.2 to about 0.5% total weight and packing the soybean tempeh chip mixture product into tubes. In examples, the tubes may be Low Density Polyethylene (LDPE) tubing and may have a diameter in a range of about 50 mm to about 110 mm, as shown in FIG. 10. Then, the LDPE tubing with the soybean tempeh chip mixture inside is kept in an incubator for about 1 to about 2 days for solid state fermentation to occur, as shown in FIG. 11.

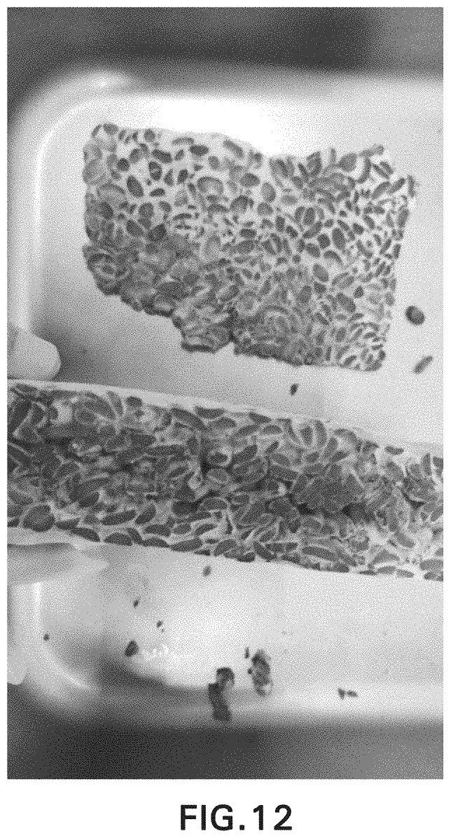

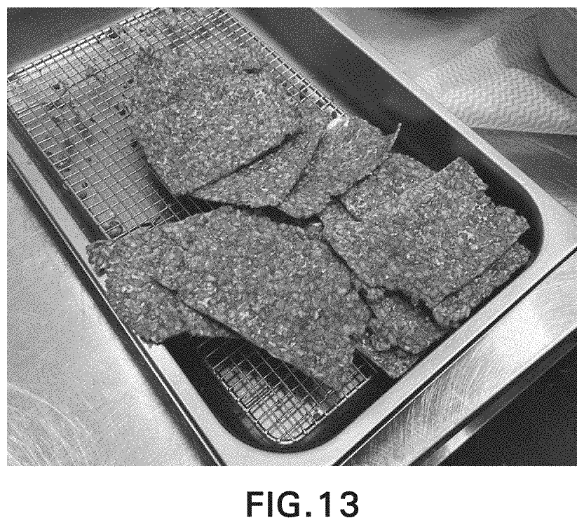

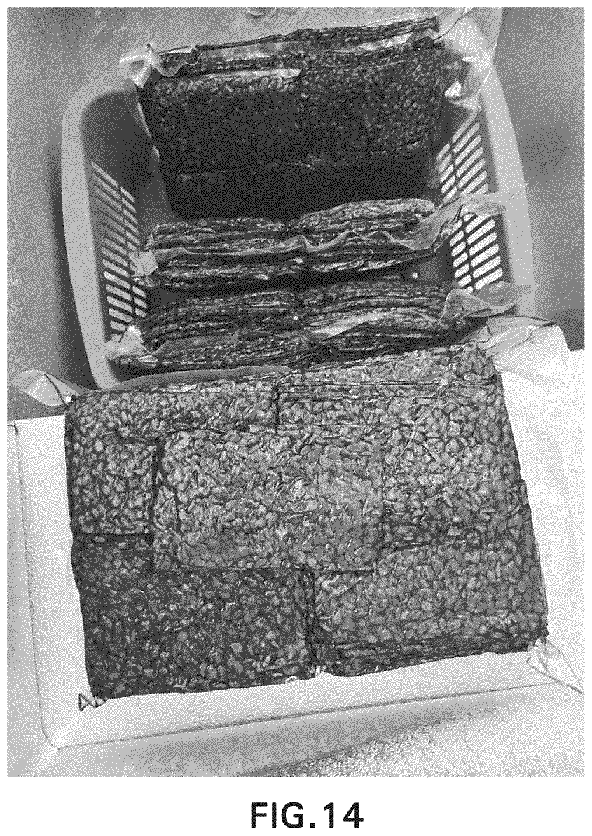

Then, the method includes slicing the LDPE tubing to form soybean tempeh chips having a thickness between about 0.7 mm to about 1.4 mm, as shown in FIG. 12 and FIG. 13. Next, the method includes frying the soybean tempeh chips in edible oils at a temperature in a range of about 160° C. to about 180° C. for a time period between about 2 minutes and about 6 minutes. The soybean tempeh chip product is shown in FIG. 14. In some examples, seasoning may be added to the soybean tempeh chip product of FIG. 14 prior to packaging the product.

### Example 6—Bak Kwa/Jerky Tempeh

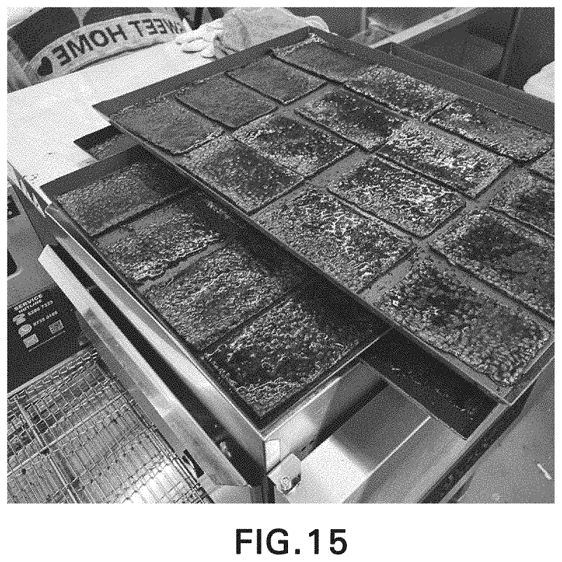

Bakkwa, also known as rougan, is a Chinese salty-sweet dried meat product similar to jerky. Bakkwa is made with a meat preservation and preparation technique. A method to create a bakkwa/jerky tempeh product includes numerous process steps, such as: soaking a dry substrate (e.g., soybeans or another substrate) with a natural or edible food coloring in a water mixture to infuse the coloring into the soy/substrate, which results in the product shown in FIG. 15. In some examples, the edible food coloring is present in an amount of about 0.1% to about 3%. This process step may occur for a time period between about 22 hours to about 24 hours. Moreover, this process step helps to mimic the meat-like visual sensory of the bakkwa/jerky tempeh product.

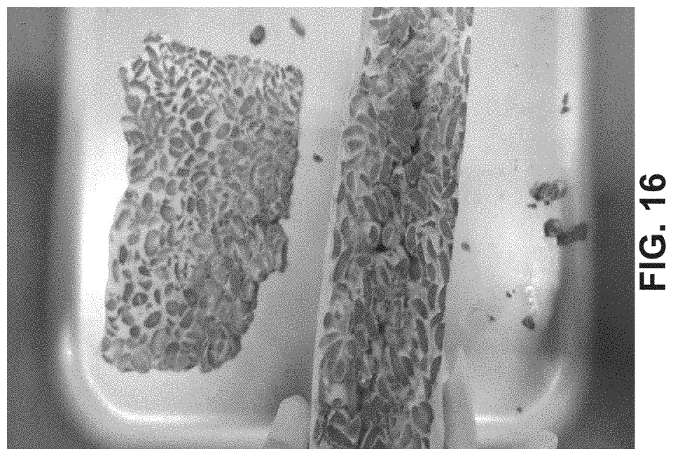

Then, the method includes rinsing the soybeans to remove waste water from lactic acid fermentation. Next, the method includes boiling the soybeans with red food coloring for a time period between about 30 minutes to one hour and adding both spices and herbs, which results in the product shown in FIG. 16. The spices and herb may include a five spice powder to infuse meat-like flavor and traditional bakkwa taste to the soybeans. In a preferred example, the spices and herbs include the following: about 1 wt. % of garlic powder, about 1 wt. % of five spice powder, about 1 wt. % of Italian herbs, about 1 wt. % of onion powder, about 1 wt. % of salt, and about 1 wt. % of pepper. Tempeh fermentation is affected negatively by the addition of onion powder, garlic powder and salt, as shown in Table 3 below.

TABLE 3

| Soy Tempeh | 0.5% | 1% | 2% |
|---|---|---|---|
| Garlic powder | Fail | Fail | Fail |
| Cinnamon | Successful | Successful | Successful |
| Italian herbs | Successful | Successful | Successful |
| Onion powder | Successful | Fail | Fail |
| Salt | Successful | Fail | Fail |
| Pepper powder | Successful | Successful | Successful |
| Fennel seed | Successful | Successful | Successful |
| Star anise | Successful | Successful | Successful |
| cloves | Successful | Successful | Successful |
| Sichuan | Successful | Successful | Successful |
| peppercorns | | | |
| Oregano | Successful | Successful | Successful |
| Basil | Successful | Successful | Successful |
| Bay leaf | Successful | Successful | Successful |
| Parsley | Successful | Successful | Successful |
| Thyme | Successful | Successful | Successful |
| Rosemary | Successful | Successful | Successful |

Then, the soybeans are dried via forced air circulation for a time period of about 10 minutes to achieve a proper humidity range for the tempeh starter to grow. Next, the tempeh starter is added to the soybeans and the herb mixture. In examples, the tempeh starter is Rhizopus oligosporus and an amount in a range of about 0.1% to about 0.4% is used. Rhizopus oligosporus is a fungus of the family Mucoraceae and is a widely used starter culture for the production of tempeh at home and industrially. As the mold grows it produces fluffy, white mycelia, binding the beans together to create an edible “cake” of partly catabolized soybeans.

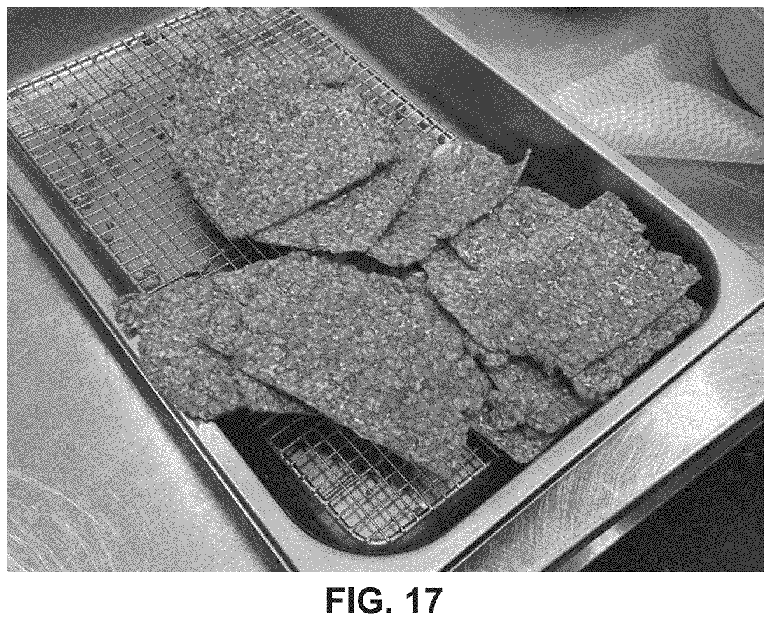

Next, the method includes about 1 to about 2 days of solid state fermentation of the bakkwa/jerky tempeh product, which results in the solid red brick-like product shown in FIG. 17. Then, the method includes slicing the bakkwa/jerky tempeh product into slices of about 5 mm thick. Then, the method includes deep frying the bakkwa/jerky tempeh product for a time period of about 3 to about 5 minutes at a temperature in a range of about 140° C. to about 180° C. This process step increases the oil content in the bakkwa/jerky tempeh product and provides a better mouthfeel end product.

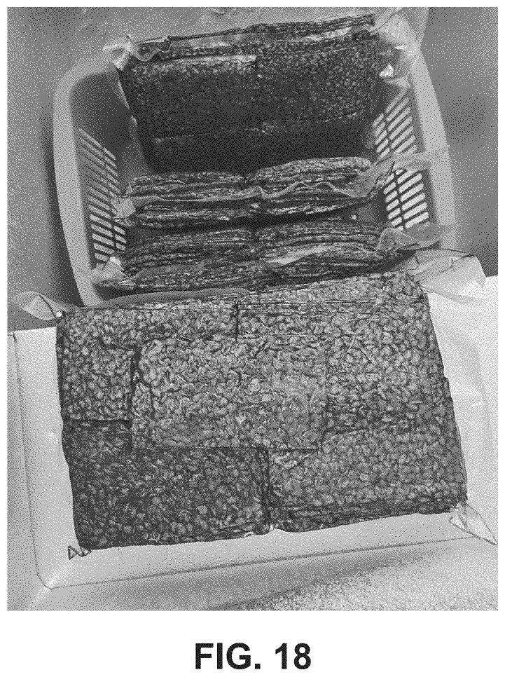

Next, the method includes vacuum sealing the bakkwa/jerky tempeh product with a sauce/marinade, as shown in FIG. 18. The sauce/marinade is between about 20% to about 50% of the initial weight of the fried tempeh product. The vacuum sealing occurs at about 90% to about 99% vacuum and helps to prevent breakage of the bakkwa/jerky tempeh product during the vacuum sealing and also allows for the incorporate of the bakkwa flavor throughout the bakkwa/jerky tempeh product.

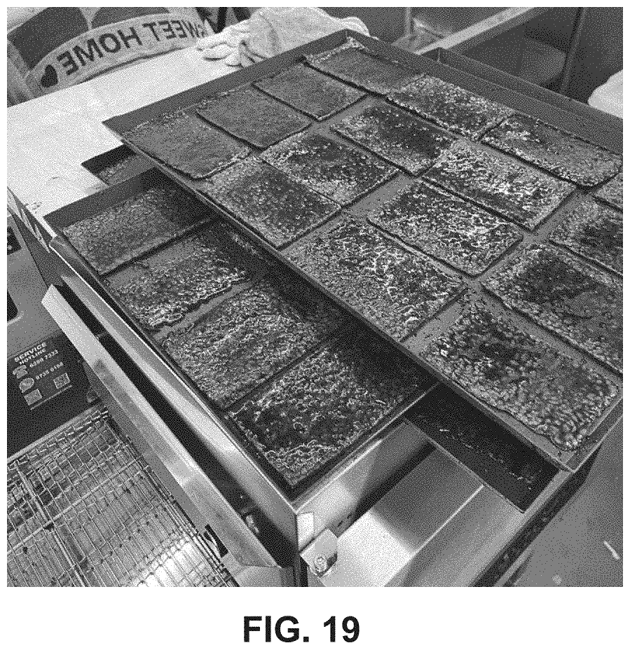

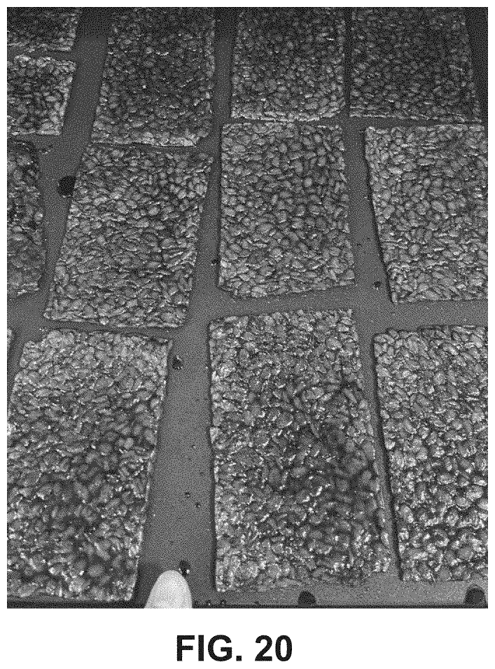

Moreover, the method includes baking the bakkwa/jerky tempeh product in an oven for a time period between about 2 minutes to about 5 minutes at a temperature of about 180° C. to about 250° C. to carnalize the sauce/marinade and make the bakkwa/jerky tempeh product chewy, as shown in FIG. 19. The final bakkwa/jerky tempeh product is shown in FIG. 20, is slightly sticky, has a chewy texture, is both sweet and savory, and has a visual appearance similar to traditional meat bakkwa/jerky products. Further, the method may include packaging the final bakkwa/jerky tempeh product.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method to create a tempeh food product, the method comprising:
soaking soybeans in a dye for a first time period;
cooking the soybeans with a component for a second time period; and
fermenting the soybeans for a third time period to form a tempeh.

2. The method of claim 1, wherein an amount of the soybeans is in a range of approximately 1 kg to approximately 30 kg.

3. The method of claim 1, wherein an amount of the dye is in a range of approximately 15 g to approximately 50 g.

4. The method of claim 1, wherein each of the first time period, the second time period, and the third time period differ.

5. The method of claim 1, wherein the component comprises a powder.

6. The method of claim 1, further comprising:
slicing the tempeh; and
cooling the tempeh to reduce a moisture content on a surface of the tempeh.

7. The method of claim 6, further comprising:
deep frying the tempeh in an oil for a fourth time period.

8. The method of claim 7, further comprising:
dipping the tempeh into a first sauce; and
cooking the tempeh in a combi oven at a first temperature for a fifth time period.

9. The method of claim 8, further comprising:
dipping the tempeh into a second sauce; and
cooking the tempeh in the combi oven at a second temperature for a sixth time period.

10. The method of claim 9, further comprising:
grilling the tempeh.

11. The method of claim 9,
wherein the first temperature differs from the second temperature, and
wherein the first time period, the second time period, the third time period, the fourth time period, the fifth time period, and the sixth time period differ.

12. The method of claim 1, wherein the tempeh comprises a tempeh bak kwa.

13. A minced food product comprising:
a soy tempeh;
an isolate; and
an oil.

14. The minced food product of claim 13, wherein the oil is selected from the group consisting of a sunflower oil and a coconut oil.

15. A chip food product comprising:
a soy tempeh or an okara; and
a starch or a flour.

16. The chip food product of claim 15, wherein a moisture level of the chip food product is in a range between approximately 50% and approximately 70%.

17. The chip food product of claim 15, wherein the flour comprises a potato starch flour.

18. The chip food product of claim 15, wherein the starch is selected from the group consisting of: a tapioca starch, potato starch, a corn starch, a wheat starch, and a rice starch.

19. The chip food product of claim 15, wherein the chip food product comprises the okara, and wherein the chip food product further comprises a tempeh starter.

20. The chip food product of claim 19, wherein the chip food product further comprises a seasoning.
